(19) United States
(12) Patent Application Publication
(10) Pub. No.: US 2006/0087939 A1
(43) Pub. Date: Apr. 27, 2006

(54) Optical disc device

(75) Inventor: Yasunori Kuwayama, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/257,120

(22) Filed: Oct. 25, 2005

(30) Foreign Application Priority Data
Oct. 26, 2004 (JP) 2004-311099

(51) Int. Cl. G11B 5/09

(52) U.S. Cl. 369/47.5; 369/47.1; 369/53.1

(57) ABSTRACT

When a main controller in an optical disc device for recording information on a rewritable optical disc having power calibration area (PCA) receives a signal from a disc detection sensor indicating the presence of optical disc, the main controller allows an optical pickup to seek to the PCA, and detects whether the PCA has free space remaining for optimum recording power control (OPC) to be performed 5 times. If it does not remain, the optical pickup subsequently erases all data recorded by trial recording in the PCA to create free space, while if it remains, the optical pickup does not perform the erasing operation. Then, the main controller along with the optical pickup performs OPC using the free space in the PCA. This makes it possible to minimize total time for OPC during the recording, and prevent occurrence of partial drop-out of recording (image cut-off) on the optical disc.

### BACKGROUND OF THE INVENTION

1. Field of the Invention

The present invention relates to an optical disc device that records information on a rewritable optical disc having a power calibration area (PCA) for controlling a recording power to an optimum level.

2. Description of the Related Art

An optical disc for recording such as a DVD (Digital Versatile Disc)-R (Recordable) or a DVD-RW (Rewritable) has a trial recording or writing area (power calibration area which is hereafter referred to as PCA). An optimum recording power (laser power) can be detected by trial recording in the PCA with different powers of a laser beam, and by reproducing the recorded data, thereby performing optimum recording power control (hereafter often referred to simply as optimum power control), which also can be referred to as optimum power calibration. In the case of a rewritable optical disc such as a DVD-RW, the data recorded by the trial recording in the PCA can be erased. Thus, if the optimum power control is repeated to cause the PCA to run out of free space (unused area) for further trial recording, it is possible to erase the data recorded by trial recordings so as to create free space, thereby enabling further optimum power control.

Regarding technologies for erasing data in the PCA, a technology to securely erase data recorded in a test area by trial recording is known, in which a test area having recorded data is subjected to erasure, and is thereafter subjected to data reproduction for determining completion of erasure. When an HF (High Frequency) signal is detected by the data reproduction from the test. area, the erasure is determined to be incomplete, and the test area is again subjected to erasure (refer to e.g. Japanese Laid-open Patent Publication 2002-298376).

Further, there is a case where a PCA is fully used, and is thereafter subjected to erasure to erase data recorded by trial recording in the entire area of the PCA, and then is further subjected to power calibration. If areas of use in the PCA are randomly selected in this case, there is a possibility that the selected areas of use in the PCA may vary in frequency of use, and that the areas exceeding a predetermined frequency of use may suffer from reduced accuracy of power calibration. A technology to solve this is known, in which, each time the power calibration is performed, a certain range of area of use from the starting address toward the inner circumference of the optical disc is subjected to erasure (refer to e.g. Japanese Laid-open Patent Publication 2003-272157).

A rewritable optical disc as described above has an advantage that there is essentially no limit in the frequency of use of the PCA usable for the optimum power control, thereby enabling recording of e.g. video on the optical disc in good condition for a long time. However, data recorded in the PCA by trial recording is to be erased in case of need (specifically, each time the PCA runs out of free space), regardless of the operating condition of the optical disc device. This may cause disadvantages as specifically described below.

As a premise of the description, an outline of a general optical disc device will be briefly described with reference to FIG. 5. An optical disc device 50 shown in FIG. 5 is one that records information such as video information on a rewritable optical disc 51 such as DVD-RW, and is connected to a television receiver 52. A television broadcast signal input from the television receiver 52 is input to an optical disc recording and reproducing unit 55 via a back end unit (B/E) 53 and a front end unit (F/E) 54 which perform digital processing. The thus input television broadcast signal is stream data, and is recorded on the optical disc 51 as a digital signal by irradiation of a laser beam from an optical pickup 56. The back end unit 53 and the front end unit 54 are provided with buffers 57 and 58, respectively, to absorb fluctuations in the speed of recording by the optical recording and reproducing unit 55 onto the optical disc 5 1.

When the optical disc device 50, using the optical pickup 56, records a desired program of a television broadcast signal onto the optical disc 51, the optical pickup 56 is assumed to perform optimum power control in the program recording as follows. That is, the optical pickup 56 once stops the recording operation of irradiating a laser beam onto the optical disc 51, and seeks from the current recording track in the recording operation to a PCA (located at the innermost circumference of the optical disc 51) onto which the optical pickup 56 again irradiates a laser beam so as to first detect whether there is an unused area in the PCA. If there is a sufficient unused area, the optical pick 56 immediately performs optimum power control by trial recording to record data on the unused area and by reproducing the recorded data.

On the other hand, if there is no sufficient unused area, the optical pickup 56 erases the data in the PCA to secure or create sufficient free space (usable area) in the PCA to perform optimum power control thereafter. In the latter case (case of erasing operation), it takes about 30 seconds from the moment the optical pickup 56 starts seeking to the PCA to the moment the optical pickup 56 resumes the recording operation after finishing the optimum power control and returning to the original recording track. In particular, it takes about 20 seconds to erase the data in the PCA.

While the recording on the optical disc 51 is paused, the buffers 57 and 58 store the stream data of the television broadcast signal. However, if the buffers 57 and 58 do not have sufficient capacity, or if the erasing operation requires a long time to lengthen the time of pausing the recording operation, then a portion of the stream data which is beyond the capacity of, and hence cannot be stored in, the buffers 57 and 58 is not recorded on the optical disc 51 after all, thereby causing an image cut-off (partial drop-out of video recording).

Since the optical disc device is designed to automatically perform optimum power control according to variations in its various states, it occurs relatively frequently to automatically start performing optimum power control in the middle of the recording of a television broadcast program. Generally, variations in states of the optical disc device which cause optimum power control include variation in ambient temperature of the optical pickup by a given temperature increase or decrease (for example 5 degrees Celsius), and variation in radial position of the optical pickup relative to the optical disc. The optimum power control for the temperature increase is to compensate for variation in the property of a semiconductor as a laser beam source, while the optimum power control for the radial positional movement of the optical pickup is to compensate for variation in the property of the optical disc itself in the radial direction such as variation of reflectivity.

### SUMMARY OF THE INVENTION

An object of the present invention is to provide such an optical disc device for recording information on a rewritable optical disc having a PCA that prevents a situation where there is no sufficient unused area remaining in the PCA for trial recording when it becomes necessary for the optical disc device to perform optimum power control during the recording operation and hence to move an optical pickup to the PCA for the trial recording, and that also prevents an operation of erasing data for securing usable area (free space) immediately before the optimum power control, thereby making it possible to minimize the total time for the optimum power control during the recording operation, and to prevent occurrence of an image cut-off (partial drop-out of recording) on the optical disc.

According to a first aspect of the present invention, the above object is achieved by an optical disc device for recording information on a rewritable optical disc having a power calibration area for optimum recording power control, the optical disc device comprising: a power calibration-capable area detecting unit which irradiates a laser beam to an optical disc from an optical pickup, having moved to the power calibration area, so as to detect whether the power calibration area still has unused space remaining in an amount equal to or more than a predetermined amount; and a trial recorded data erasing unit which irradiates a laser beam to the optical disc so as to erase data recorded by trial recording in the power calibration area, if the detection by the power calibration-capable area detecting unit indicates that the power calibration area has insufficient unused area remaining that is less than the predetermined amount.

Therein, the power calibration-capable area detecting unit detects the amount of unused area in the power calibration area between the moment the optical disc is mounted and the moment record command is input to start recording operation on the optical disc, wherein if the detection by the power calibration-capable area detecting unit indicates that the power calibration area has insufficient unused area remaining that is less than the predetermined amount, then the trial recorded data erasing unit erases, at the time of the detection, the data recorded by the trial recording in the power calibration area.

According to the first aspect of the present invention, when it becomes necessary for the optical disc device to perform optimum recording power control during the recording operation and hence to move an optical pickup to the power calibration area for the trial recording, the optical disc device prevents a situation where there is no sufficient unused area remaining in the power calibration area for trial recording, and makes it possible that the optical pickup having moved to the power calibration area starts the optimum recording power control immediately. Thereby, the total time required for the optimum recording power control is reduced, minimizing the amount of data to be stored in buffers during the optimum recording power control, so that partial drop-out of recording can be prevented from occurring.

Preferably, the predetermined amount of the unused area is such that the optimum recording power control can be performed about 5 times in the unused area. This is preferable because when an optical disc is subjected to recording of video information, opportunities of about 5 times are normally generated for the optimum recording power control.

According to a second aspect of the present invention, the above object is achieved by an optical disc device for recording information on a rewritable optical disc having a power calibration area for optimum recording power control, the optical disc device comprising: an optical disc detecting unit for detecting that an optical disc is mounted in the optical disc device; an optical pickup moving unit for moving an optical pickup to the power calibration area; a power calibration-capable area detecting unit which irradiates a laser beam to an optical disc from an optical pickup, having moved by the optical pickup moving unit to the power calibration area, so as to detect whether the power calibration area still has unused space remaining in a certain amount equal to or more than an amount to enable the optimum recording power control to be performed about 5 times; and a trial recorded data erasing unit which irradiates a laser beam to the optical disc so as to erase data recorded by trial recording in the power calibration area, if the detection by the power calibration-capable area detecting unit indicates that the power calibration area has insufficient unused area remaining that is less than the certain amount.

Therein, the power calibration-capable area detecting unit detects the amount of unused area in the power calibration area when the optical disc is mounted, wherein if the detection by the power calibration-capable area detecting unit indicates that the power calibration area has insufficient unused area remaining that is less than the certain amount, then the trial recorded data erasing unit erases, at the time of the detection, the data recorded by the trial recording in the power calibration area.

According to the second aspect of the present invention, if, when the optical disc is mounted in the optical disc device, the detection by the power calibration-capable area detecting unit indicates that the power calibration area has insufficient unused area remaining in a certain amount equal to or more than an amount to enable the optimum recording power control to be performed about 5 times, then the trial recorded data erasing unit erases, at the time of the detection, the data recorded by the trial recording in the power calibration area. Thus, when it becomes necessary for the optical disc device to perform optimum recording power control during the recording operation and hence to move an optical pickup to the power calibration area for the trial recording, the optical disc device prevents a situation where there is no sufficient unused area remaining in the power calibration area for trial recording, and makes it possible that the optical pickup having moved to the power calibration area starts the optimum recording power control immediately. Thereby, the total time required for the optimum recording power control is reduced, minimizing the amount of data to be stored in buffers during the optimum recording power control, so that partial drop-out of recording can be prevented from occurring.

Furthermore, according to the second aspect of the present invention, both the operation of detecting the amount of unused area in the power calibration area and the operation of erasing the data recorded by trial recording are performed by the optical disc device together when the optical disc is mounted in the optical disc device. Thus, when the user thereafter commands the optical disc device for various operations such as video reproduction, such operations are not interrupted by the operation of erasing the data recorded by trial recording.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram schematically showing a DVD recorder according to an embodiment of the present invention;

FIG. 2 is a flow chart showing a process of optimum recording power control for a laser beam in the DVD recorder at the time an optical disc is mounted therein;

FIG. 3 is a view schematically showing a power calibration area (PCA) of the optical disc mounted in the DVD recorder;

FIG. 4 is a flow chart showing a process of the optimum recording power control performed by the DVD recorder when recording; and

FIG. 5 is a schematic view showing an outline of a general optical disc device when connected to a television receiver.

### DESCRIPTION OF THE PREFERRED EMBODIMENTS

Embodiments of the present invention, as best mode for carrying out the invention, will be described hereinafter with reference to the annexed drawings. It is to be understood that the embodiments described herein are not intended as limiting, or encompassing the entire scope of, the invention. The following description exemplifies a case where the present invention is applied to such a DVD (Digital Versatile Disc) recorder, with a DVD-RW (Rewritable) mounted thereon as an optical disc having a power calibration area (PCA), that can record various information such as video information on the optical disc (DVD-RW), and can reproduce information recorded on the optical disc (DVD-RW).

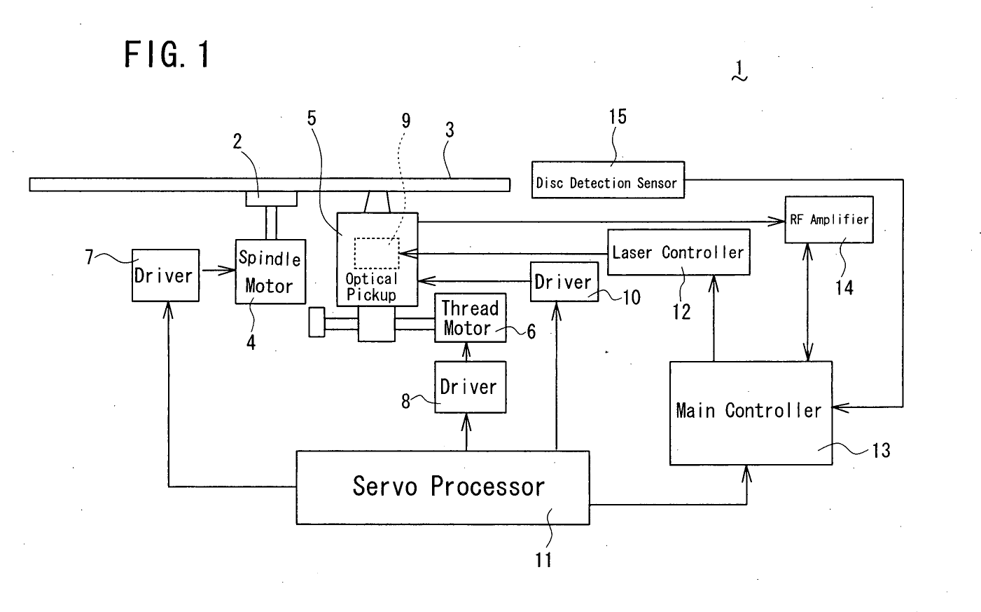

FIG. 1 is a block diagram schematically showing a DVD recorder 1 according to an embodiment of the present invention. As shown in FIG. 1, the DVD recorder 1 of the present embodiment comprises: a spindle motor 4 for rotating an optical disc 3 mounted on a turntable 2; a thread motor 6 for moving an optical pickup 5 in a radial direction of the optical disc 3; and drivers 7 and 8 for driving the spindle motor 4 and the thread motor 6. The optical pickup 5 includes a focusing actuator (not shown) and a tracking actuator (not shown) for positioning a focus of a laser beam emitted from a semiconductor laser beam source 9 on a given track on the optical disc 3, and further includes a driver 10 for driving the focusing actuator and the tracking actuator. These drivers 7, 8 and 10 are connected to a servo processor 11.

It is designed so that the semiconductor laser beam source 9 can be controlled or adjusted to increase or decrease the intensity of the laser beam (laser power) by a laser controller 12 controlled by a main controller 13 which is formed of a microcomputer. The main controller 13 further controls the servo processor 11, and receives an RF (Radio Frequency) signal output from the optical pickup 5 via an RF amplifier 14. The DVD recorder 1 further comprises a disc detection sensor 15 for detecting the presence or absence of the optical disc 3 on the turntable 2. A detection signal from the disc detection sensor 15 is input to the main controller 13 so that the main controller 13 can detect the optical disc 3 when mounted on the turntable 2. Thus, according to the present embodiment, the main controller 13 along with other elements including the disc detection sensor 15 serves as an optical disc detecting unit for detecting that the optical disc 3 is mounted in the DVD recorder 1 (optical disc device).

Note that for detecting the mounted optical disc 3 in the present embodiment, the disc detection sensor 15 is used, but various other means can be used instead. For example, the optical disc 3, when mounted, can be detected by detecting the presence or absence of light reflected from the surface of the mounted optical disc 3, which is initially irradiated thereto from the optical pickup 5.

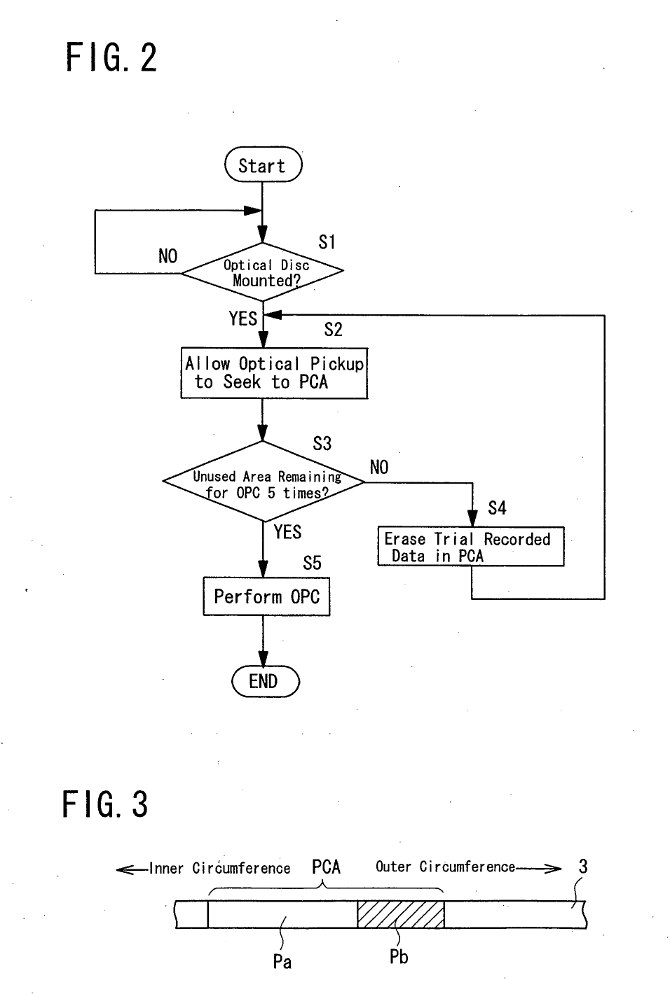

Referring now to the flow chart of FIG. 2, the following describes a process of optimum recording power control performed by the main controller 13 for the laser beam at the time the optical disc 3 is mounted in the DVD recorder 1. Hereafter, the term “optimum recording power control” which also can be referred to as optimum power calibration, and can be abbreviated as OPC, will often be referred to simply as optimum power control. When the main controller 13 receives a signal from the disc detection sensor 15 indicating the presence of optical disc (detection signal of detecting the mounting of the optical disc) (YES in SI), the main controller 13 sends a signal to the servo processor 11 to drive the thread motor 6 so as to allow the optical pickup 5 to seek to the PCA (S2). Thus, according to the present embodiment, the main controller 13 along with other elements including the servo processor 11 and the thread motor 6 serves as an optical pickup moving unit for moving the optical pickup 5 to the PCA.

The PCA is formed on an innermost circumference of the optical disc 3. In the case of DVD-RW, data for trial recording is recorded starting from the outer circumferential side of the PCA. This is schematically shown in FIG. 3. Normally, a PCA has space secured or reserved therein to enable optimum power control to be performed about 100 times. FIG. 3 shows a state where about 40% of the PCA is used as indicated by Pb (used area), leaving about 60% of the PCA as free space as indicated by Pa (unused area) (for optimum power control to be performed about 60 times).

The main controller 13 along with the servo processor 11 and so on controls the optical pickup 5 to seek to the PCA as described above, and then detects whether the PCA still has free space remaining therein for the optimum power control (OPC) to be performed 5 times (S3). More specifically, the optical pickup 5 irradiates a laser beam onto the surface of the optical disc 3 while seeking from the innermost circumferential position to the outer circumference of the PCA as shown in FIG. 3, and uses the reflected light to separately detect the area (unused area) Pa in the PCA with no recorded data and the area Pb with recorded data. In the present, embodiment, the optical pickup 5 detects whether the PCA still has free space (unused area) Pa remaining for the optimum power control to be performed 5 times. This means that the optical pickup 5 detects, under the control of the main controller 13 and so on, whether at least 5% of the PCA still remains as the free space Pa. Note that the amount of the remaining free space Pa required is not limited to the amount for the optimum power control to be performed 5 times, and that the number of times the optimum power control is required to be performed in the remaining free space Pa can be appropriately set. The reason for the preference of 5 times in the present embodiment will be described later.

If NO in the step S3, the main controller 13 controls the laser controller 12 to in turn control the optical pickup 5 to erase all data recorded by trial recording in the PCA (S4), and goes back to the step S2 to ultimately perform optimum power control using the free space in the PCA (S5). On the other hand, if YES in the step S3, the main controller 13 controls the laser controller 12 to in turn control the optical pickup 5 to perform optimum power control using free space Pa remaining. in the PCA without performing the erasing operation (S5). In order to erase the. data recorded by trial recording in the PCA, the optical pickup 5 seeks across the entire area of the PCA under the control of the main controller 13, the servo processor and so on, and irradiates, onto the surface of the optical disc 3 while seeking, a laser beam having an intensity comparable to that used for the recording. Accordingly, after the erasing operation in the step S4, the entire area in the PCA becomes an area usable for the optimum power control, that is free space.

As evident from the above, the main controller 13 along with other elements including the laser controller 12 and the optical pickup 5 serves: as a power calibration-capable area detecting unit which irradiates a laser beam to the optical disc 3 from the optical pickup 5, having moved to the PCA, so as to detect whether the PCA still has unused space remaining in an amount equal to or more than a predetermined amount; and as a trial recorded data erasing unit which irradiates a laser beam onto the optical disc 3 so as to erase data recorded by trial recording in the PCA, if the detection by the power calibration-capable area detecting unit indicates that the PCA has insufficient unused area remaining that is less than the predetermined amount.

As described above, in the DVD recorder 1 according to the present embodiment, the main controller 13 controls the optical pickup 5 to detect whether the unused area Pa in the PCA still has an amount remaining to enable the optimum power control to be performed 5 times. If remaining, the main controller 13 along with the optical pickup 5 performs optimum power control, while if not remaining, the main controller 13 along with the optical pickup 5 continues erasing data recorded by trial recording. Thus, when the DVD recorder 1 records e.g. a television broadcast signal thereafter, the DVD recorder 1 performs a process as follows.

Now assume that the DVD recorder 1 of the present embodiment is connected to a television receiver as shown in FIG. 5. If a user wishes to record a television broadcast program, and operates e.g. a remote control to input record command, the optical pickup 5 performs digital recording onto an optical disc 3 (DVD-RW) while seeking from the inner circumference to the outer circumference of the optical disc 3. Each time the ambient temperature of the optical pickup 5 increases by 5 degrees Celsius (given temperature) during the recording operation, the DVD recorder 1 detects the temperature increase, using a temperature sensor (not shown) provided therein, to pause the recording operation, and allows the optical pickup 5 to seek to the PCA so as to perform optimum power control. Similarly, each time the recording operation causes the optical pickup 5 to move by a given distance in a radial direction of the optical disc 3 (each time the record address changes), the DVD recorder 1 pauses the recording operation and performs optimum power control.

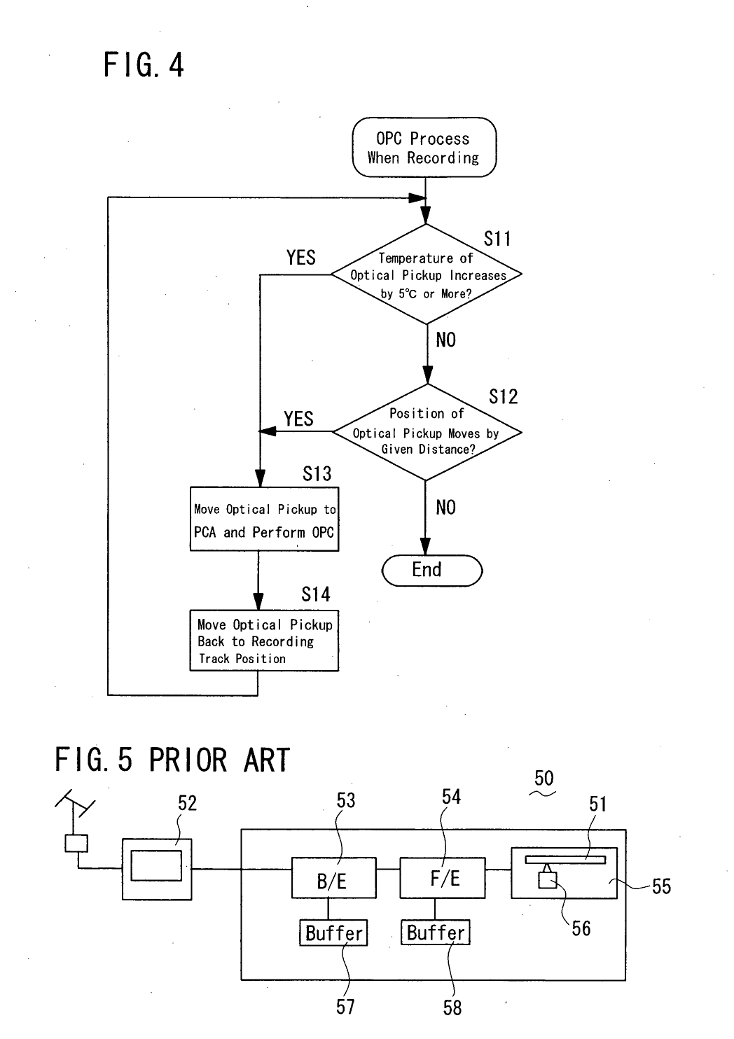

Referring now to the flow chart of FIG. 4, the following describes a process performed by the DVD recorder 1 when recording. When the ambient temperature of the optical pickup 5 increases by 5 degrees Celsius or more (YES in S11), or when the position of the optical pickup 5 moves by a given distance or more (YES in S12), the DVD recorder 1 (main controller 13) controls to move the optical pickup 5 to the PCA and perform optimum power control (S13), and further controls to move the optical pickup 5 back to recording track position again (S14).

As indicated by the above description, when the DVD recorder 1 continues the recording operation onto the optical disc 3, the inside temperature of the DVD recorder 1 gradually increases due to heat generation caused by operations of various units and elements in the DVD recorder 1, and the position of the optical pickup 5 moves. Normally, when an optical disc such as the optical disc 3 (DVD-RW) is subjected to recording of video information, opportunities of about 5 times are generated for the optimum power control.

The feature of the DVD recorder 1 according to the present embodiment as described above is that it can skillfully perform the optimum power control. More specifically, when the optical disc 3 is mounted on the DVD recorder 1, it is secured that the PCA of the optical disc 3 has unused area Pa (free space) remaining therein for the optimum power control to be performed at least 5 times. Thus, when thereafter the user inputs record command to start the process as shown by the flow chart of FIG. 4 so as to perform the optimum power control in the step S13, the DVD recorder 1 is not required to perform an erasing operation. Accordingly, the time to pause the recording operation is minimized to be equal to only the sum of the time required to move the optical pickup 5 and the time required to perform the optimum power control (OPC), while sufficient data to be recorded at the time the recording operation is paused is stored in a buffer in the DVD recorder 1. This makes it possible to prevent partial drop-out of video recording (image cut-off) on the optical disc 3.

In the embodiment described above, the DVD recorder 1 detects that the optical disc 3 is mounted therein, and secures unused area Pa, at the time of the mounting of the optical disc 3, to enable the optimum power control to be performed at least 5 times. In other words, the DVD recorder 1 completes a series of operations required to secure or reserve necessary unused area in the PCA at the time the optical disc 3 is mounted in the DVD recorder 1. Thus, when the user thereafter commands the DVD recorder 1 (optical disc device) for various operations, such operations are not interrupted by e.g. an operation of erasing recorded data for trial recording.

It is to be noted that the present invention is not limited to the above-described specific embodiment, and various modifications are possible. For example, the above embodiment describes the case where optimum power control is performed so as to compensate for variation in the property of a semiconductor laser beam source due to temperature variation, each time the ambient temperature of the optical pickup 5 increases 5 degrees Celsius or more. However, the temperature of 5 degrees Celsius for the temperature setting can be changed to other temperatures such as 3 or 6 degrees. Furthermore, the above embodiment describes the case where unused area Pa for the optimum power control to be performed at least 5 times is secured in the PCA at the time the optical disc 3 is detected when mounted in the DVD recorder. However, the number of times the optimum power control is required to be performed in the unused area Pa can be appropriately set to be about 5 times or other times. Further, the timing of securing a predetermined amount of unused area Pa in the PCA (or the timing of erasing data recorded in the PCA for trial recording if the amount of the unused area is insufficient or less than a predetermined amount) can be anytime from the moment the optical disc 3 is mounted to the moment the user inputs record command to start the recording operation.

Describing this in another way, the power calibration-capable area detecting unit detects the amount of unused area in the PCA between the moment the optical disc 3 is mounted and the moment the record command is input to start the recording operation on the optical disc 3. If the detection by the power calibration-capable area detecting unit indicates that the PCA has insufficient unused area remaining that is less than the predetermined amount, then the trial recorded data erasing unit erases, at the time of the detection, the data recorded by trial recording in the PCA.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. An optical disc device for recording information on a rewritable optical disc having a power calibration area for optimum recording power. control, the optical disc device comprising:
a power calibration-capable area detecting unit which irradiates a laser beam to an optical disc from an optical pick-up, having moved to the power calibration area, so as to detect whether the power calibration area still has unused space remaining in an amount equal to or more than a predetermined amount; and
a trial recorded data erasing unit which irradiates a laser beam to the optical disc so as to erase data recorded by trial recording in the power calibration area, if the detection by the power calibration-capable area detecting unit indicates that the power calibration area has insufficient unused area remaining that is less than the predetermined amount,
wherein the power calibration-capable area detecting unit detects the amount of unused area in the power calibration area between the moment the optical disc is mounted and the moment record command is input to start recording operation on the optical disc, and
wherein if the detection by the power calibration-capable area detecting unit indicates that the power calibration area has insufficient unused area remaining that is less than the predetermined amount, then the trial recorded data erasing unit erases, at the time of the detection, the data recorded by the trial recording in the power calibration area.

2. The optical disc device according to. claim 1, wherein the predetermined amount of the unused area is such that the optimum recording power control can be performed about 5 times in the unused area.

3. An optical disc device for recording information on a rewritable optical disc having a power calibration area for optimum recording power control, the optical disc device comprising:
an optical disc detecting unit for detecting that an optical disc is mounted in the optical disc device;
an optical pickup moving unit for moving an optical pickup to the power calibration area;
a power calibration-capable area detecting unit which irradiates a laser beam to an optical disc from an optical pickup, having moved by the optical pickup moving unit to the power calibration area, so as to detect whether the power calibration area still has unused space remaining in a certain amount equal to or more than an amount to enable the optimum recording power control to be performed about 5 times; and
a trial recorded data erasing unit which irradiates a laser beam to the optical disc so as to erase data recorded by trial recording in the power calibration area, if the detection by the power calibration-capable area detecting unit indicates that the power calibration area has insufficient unused area remaining that is less than the certain amount,
wherein the power calibration-capable area detecting unit detects the amount of unused area in the power calibration area when the optical disc is mounted, and
wherein if the detection by the power calibration-capable area detecting unit indicates that the power calibration area has insufficient unused area remaining that is less than the certain amount, then the trial recorded data erasing unit erases, at the time of the detection, the data recorded by the trial recording in the power calibration area.
